(19) United States
(12) Patent Application Publication
(10) Pub. No.: US 2020/0317471 A1
(43) Pub. Date: Oct. 8, 2020

(54) SYSTEM FOR MEASURING NOISE, VIBRATION AND RUNNING SPEED OF ELEVATOR AND ESCALATOR

(71) Applicant: KOREA ELEVATOR SAFETY AGENCY, Jinju-si, Gyeongsangnam-do (KR)

(72) Inventors: Yun Kyum KIM, Suwon-si (KR); Chan Yong PARK, Seoul (KR)

(73) Assignee: KOREA ELEVATOR SAFETY AGENCY, Jinju-si, Gyeongsangnam-do (KR)

(21) Appl. No.: 16/314,157

(22) PCT Filed: Dec. 18, 2017
(86) PCT No.: PCT/KR2017/014908

§ 371 Date: Dec. 28, 2018

(30) Foreign Application Priority Data
Feb. 16, 2017 (KR) 10-2017-0020821

(51) Int. Cl. B66B 5/00; G01D 21/02; G08C 17/00

(52) U.S. Cl. CPC B66B 5/0031; G01D 21/02; G08C 2201/30; G08C 17/00; B66B 5/0037

(57) ABSTRACT

The present invention relates to a system for measuring noise, vibration and running speed of an elevator, wherein the system can measure noise, vibration, running speed, etc. of an elevator through wireless communication in a state in which an operator is not in the elevator, to analyze riding quality, running state etc. The present invention provides a system for measuring noise, vibration and running speed of an elevator and an escalator, the system comprising: a measurement body 31 installed on an inner floor or a step tread 21 of an elevator 10 or an escalator 20; an acceleration sensor 32 and noise sensor 33 installed in the measurement body 31; and a display device 35 allowing data obtained by the acceleration sensor 32 and noise sensor 33 to be identified outside through wireless communication.

### TECHNICAL FIELD

The present invention relates to a system for measuring noise, vibration and running speed of an elevator and an escalator, and more particularly to a system for measuring noise, vibration and running speed wherein the system can measure noise, vibration, running speed, etc. of an elevator through wireless communication in a state in which an operator is not in the elevator, to analyze ride quality, a running state etc.

### BACKGROUND ART

Generally, an elevator is an apparatus which is installed in a multistory building to run up and down, it is necessary to do periodic safety inspection in order to check parts deterioration or wear to maintain smooth operation and prevent safety related accident, and also it is necessary to measure noise, vibration, running speed etc. and analyze them to diagnose ride quality or performance of elevator.

Conventionally, measuring of noise, vibration and running speed of the elevator is implemented by a measurement body placed in the elevator case, and the measurement body comprises of a vibration sensor to detect horizontal and vertical vibration and a display device connected to the measurement body to collect and analyze the date detected by the vibration sensor. But to do measuring work, the operator should ride on the elevator together with the measurement body and the display device being placed in the elevator, which is inconvenient for measuring work because man and measuring apparatus are placed in a restricted space together, and it may be even dangerous because the elevator is running while the operator rides on.

Considering the above problem, there was provide a measuring system in which the measurement body is communicated with the display device wirelessly and the operator need not ride on the elevator to solve the safety problem, but in this case accurate measurement analysis could not be achieved due to the data loss and transmission failure by wireless communication trouble.

### DISCLOSURE

### Technical Problem

The present invention is proposed to solve the above problems, and the object of the invention is to provide a system for measuring noise, vibration and running speed of an elevator, wherein the system can measure noise, vibration, running speed, etc. of an elevator through wireless communication in a state in which an operator is not in the elevator, to analyze ride quality, a running state etc., and construction of the measurement device is simple and compact to make it easy for handling, transporting and storing.

### Technical Solution

According to an aspect of the present invention, there is provided a system for measuring noise, vibration and running speed of an elevator and escalator which comprises:
a measurement body 31 to be installed on the inner floor or a step tread 21 of an elevator 10 or an escalator 20;
an acceleration sensor 32 installed on the measurement body 31 to detect the acceleration of the running elevator 10 or escalator 20;
a noise sensor 33 connected to the measurement body 31 to detect noise inside the elevator 10 or noise on the predetermined position above the step tread 21 of the escalator 30;
a control unit 34 installed on the measurement body 31 to receive and process data from the acceleration sensor 32 and the noise sensor 33 and the control unit having a communication module 46 to communicate with outer device wirelessly and a memory 47 to save the data from the acceleration sensor 32 and the noise sensor 33; and
a display device 35 being separated from the measurement body 31, receiving data from the measurement body 31 and displaying the data including speed, vibration, decibel of noise and angle by numerical value or graph; wherein
the control unit 34 being capable of communicating with the display device 35 in real time, and if data omission happens due to communication disruption, a data saved in the memory 47 should be transmitted again to the display device 35 when communication is recovered so that they can be displayed through the display device 35.

According to the other aspect of the present invention, there is provided a system for measuring noise, vibration and running speed of an elevator and escalator, wherein the system further includes a supporting plate 50 having three legs 53 to be placed on the floor of elevator or the step tread 21 of the escalator 21, on which the measurement body 31 is installed.

According to the other aspect of the present invention, there is provided a system for measuring noise, vibration and running speed of an elevator and escalator, wherein the legs 51 are formed of tapered shape in which the cross section gradually reduces toward the floor of the elevator 10 or the step tread 21 of the escalator.

### Advantageous Effect

According to the present invention, as the measurement 31 can transmit the data to the display device 31 through wireless communication, the operator can do measuring work without riding on the elevator 10 or the escalator 20, which will reduce the safety problem, and the operator can easily place the measurement components on the enough space of the elevator 10 or the escalator 20.

And, according the present invention, as the control unit 34 can communicate with the display device 35 in real time, and if data omission happens due to communication disruption, a data saved in the memory 47 can be transmitted again to the display device 35 when communication is recovered so that they can be displayed through the display device 35, which will make it possible to display measuring state regardless of communication condition and will increase the reliability of the measurement due to the accurate analysis.

And, according to the present invention, as the system further includes a supporting plate 50 having three legs 53 to be placed on the floor of elevator or the step tread 21 of the escalator 20, and the legs 51 are formed as tapered shape in which the cross section gradually reduces toward the floor of the elevator 10 or the step tread 21 of the escalator 20, the pressure due to the weight of the measurement body 31 on the floor of the elevator 10 or the step tread 21 of the escalator can be increased. Therefore, even though the measurement body 31 is made to be small size and light weight, the required pressure for accurate measuring (e.g. 60 kPa according to local code) by sufficient and accurate transmission of vibration etc. can be achieved with smaller and lighter measurement body 31, which will be advantageous in transporting and handling the measurement body 31.

### DESCRIPTION OF THE DRAWINGS

FIG. 1 is a perspective showing the installing state of one embodiment of the present invention

FIG. 2 is an exploded view of the embodiment of the present invention

FIG. 3 is another exploded view of the embodiment of the present invention

FIG. 4 is a front view showing a portion of the embodiment of the present invention

FIG. 5 is a block diagram of the embodiment of the present invention

FIG. 6 is a flow chart of the operation of the embodiment of the present invention

FIG. 7 is a flow chart of the operation of another embodiment of the present invention

FIG. 8 is an exemplary graph showing the operation of the embodiment of the present invention

FIG. 9 is a view showing the installing state of another embodiment of the present invention

FIG. 10 is a block diagram of another embodiment of the invention

FIG. 11 is a flow chart of the operation of another embodiment of the present invention

### DETAILED DESCRIPTION OF THE INVENTION

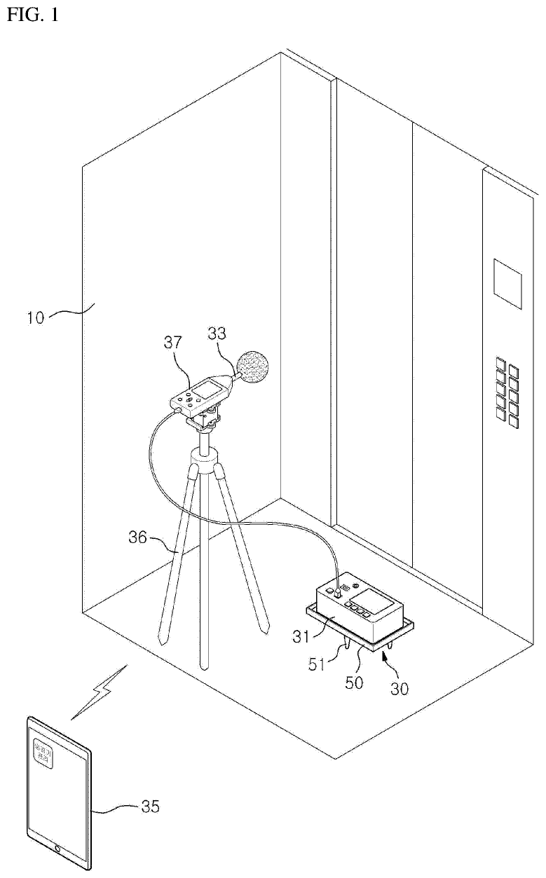

Hereinafter, the preferred embodiments of the present invention will be described with reference to the drawings. FIG. 1 to FIG. 11 show various embodiment of the invention.

Referring FIG. 1, the present invention is to measure noise, vibration or running speed of the elevator 10 to analyze riding quality, running state etc., and it comprises a measurement device 30 installed in the elevator 10 to measure noise, vibration and speed of the elevator 10, and a display device 30 portable by the operator and receiving data from the measurement device 10 wirelessly, analyzing and displaying them.

The measurement device 30 comprises a measurement body 31 to be installed on the floor of the elevator 10 and measuring noise and speed etc., and a noisemeter 37 placed on the tripod 36 beside the measurement body 31 and having a noise sensor 33. The measurement body 31 can detect vibration or running speed as it is installed on the floor of the elevator 10 so that it can measure and diagnose actual noise and vibration transmitted through the foot of rider, and the noisemeter 37 is positioned about lm and more above the floor so that it can measure the actual noise level the rider can feel as he stands on the floor, therefore, the accuracy and reliability of measurement can be obtained.

The display device 35 may be a tablet PC or a smart phone on which measuring program or application is installed, and it can communicate with the measurement body 31 wirelessly and control to initiate and finish measurement. The operator can control the operation of initiating, adjusting, selecting, reviewing or finishing measurement through the display device 35 in a state in which an operator is not in the elevator.

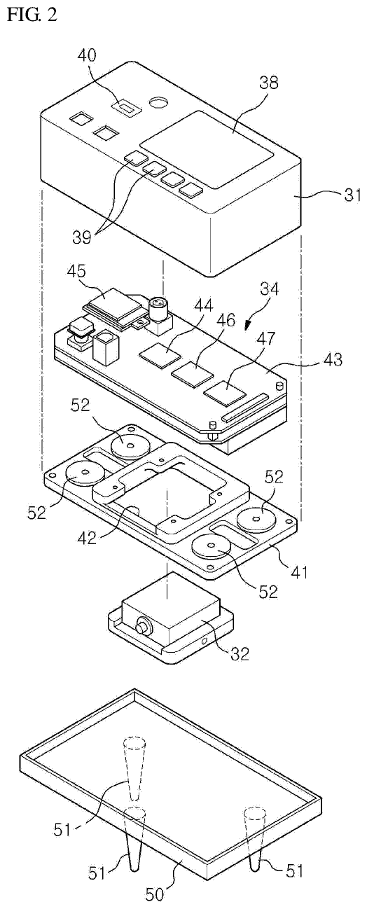

Referring to FIG. 2 to FIG. 8 show the detailed construction and installing state. As shown in FIG. 2, the measurement body 31 is formed of rectangular shape and includes a display panel 38, an operating button 39 and connector 40 so that it can manipulate on/off, setting and connecting to outer device such as the noisemeter 37 through cable. In the measurement body 31, there are provided a control unit 34 connected with an acceleration sensor 32 detecting the vibration and speed and a noise sensor 33, and a base panel 41 having an insert hole 42 in which the acceleration sensor 32 is to be inserted is provided on the lower of the measurement body 31.

The control unit 34 comprises a main board 43 of PCB type, a convertor 44 calculating or processing the data detected by the acceleration sensor 32 and the noise sensor 33, and CPU 45, a communication module 46 with wireless protocol such as Wi-Fi to communicate with the display device 35, and a memory 47 to save the data obtained by the acceleration sensor 32 and the noise sensor 33.

The acceleration sensor 32 is a 3 axial sensor which can detect the inclination of horizontal direction of X axis and Y axis and vertical direction of Z axis, this acceleration sensor 32 can measure the acceleration value while the elevator is running, and it can be processed to obtain values of speed, distance or vibration.

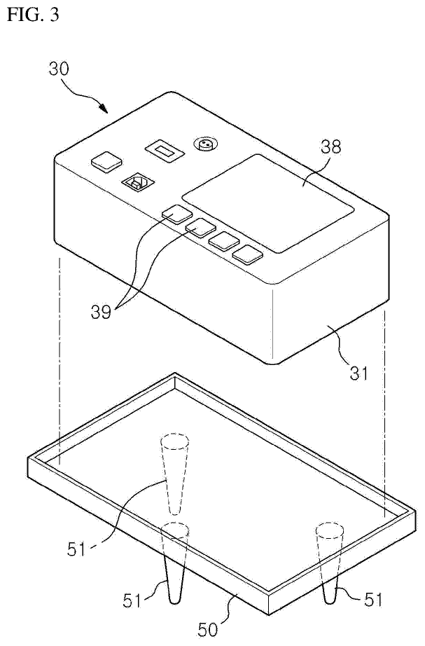

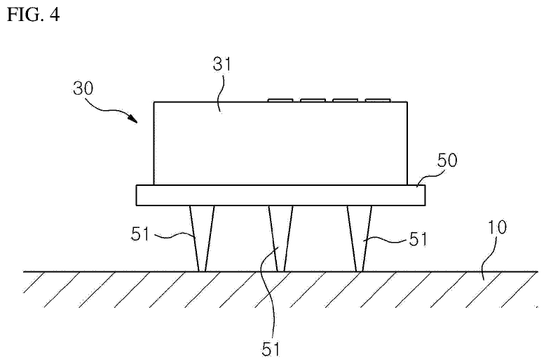

The measurement body 31 is placed on the supporting plate 50, which is explained in referring to FIGS. 3 and 4. The supporting plate 50 has three legs 51 which are supported on the floor of the elevator 10 at three points. The legs 51 are formed of tapered shape in which the cross section gradually reduces toward the floor of the elevator 10. Accordingly, the pressure due to the weight of the measurement body 31 on the floor of the elevator 10 or the step tread 21 of the escalator can be increased. Therefore, even though the measurement body 31 is made to be small size and light weight, the required pressure for the accurate measuring (e.g. 60 kPa according to local code) can be achieved with smaller and lighter measurement body 31, which will be advantageous in transporting and handling the measurement body 31.

As shown in FIG. 2, three or four magnets 52 are provided on the lower panel of the measurement body 31, and the measurement body 31 can be firmly attached on the supporting plate 50, therefore the vibration of the elevator cage can be certainly transmitted to the acceleration sensor 32 of the measurement body 31, and any noise vibration or rocking generating between the measurement body 31 and the supporting plate 50 can be effectively prevented to achieve accurate measurement.

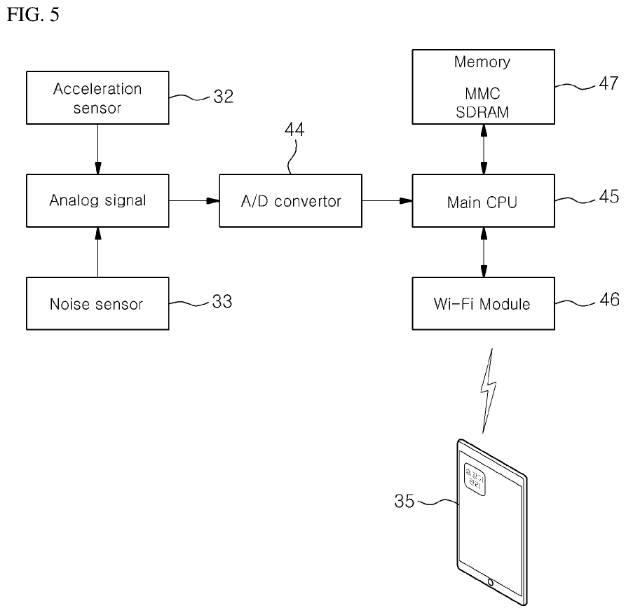

According to the present invention, data generated from the measurement body 31 can be transmitted to the display device to be displayed in real time, then if data omission happens due to communication disruption, the omitted data can be transmitted again to the display device 35 when communication is recovered so that they can be displayed through the display device 35, which will make it possible to display complete measuring state regardless of communication condition and will increase the reliability of the measurement due to the accurate analysis, and the above process will be explained in referring to FIGS. 5 to 8.

FIG. 5 shows the transmitting process from the control unit 34 on the measurement body 31 to the display device 35. As measuring is initiated, signal of analog type detected by the acceleration sensor 32 and the noise sensor 33 is input to the control unit 34 and converted into digital signal by the convertor 44, and this digital data is transmitted through the communication module 46 to the display device 35 as well as it is saved on the memory 47. The data is displayed in the display device 35 in the numeral value or graph.

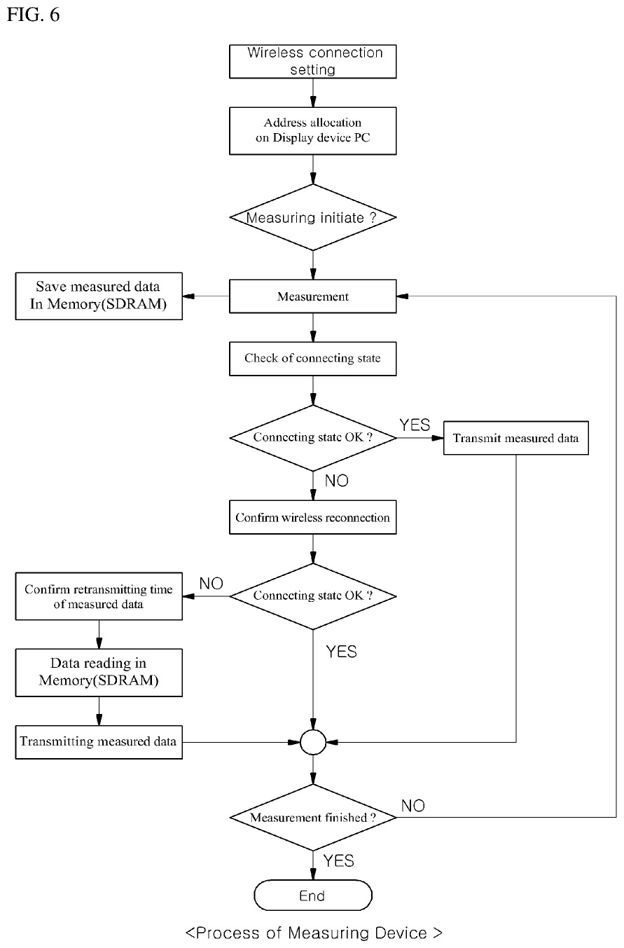

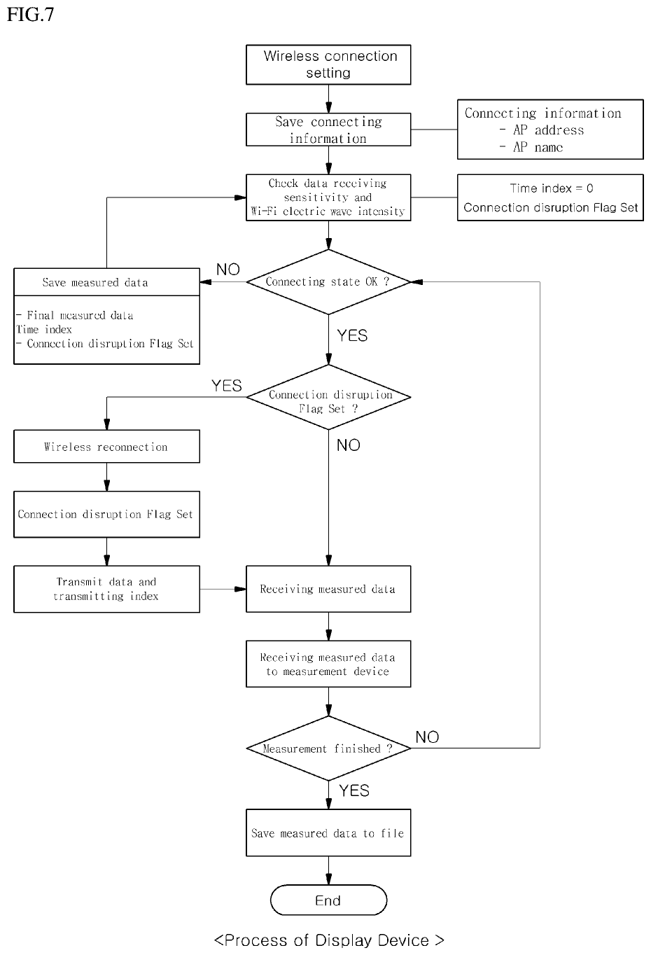

As shown in FIGS. 6 to 7, data communication process between the control unit 34 and the display device 35 is as follows.
1. On starting measurement, Connecting information of the measurement device 30 is to be set as the AP of communication module 46 such as Wi-Fi is saved, and the connecting information includes address and name of AP.
2. On starting measurement, Time index of the measuring information is to be set as ‘0’ and Connecting Interruption flag is to be reset.
3. On starting measurement, data receiving sensitivity (connecting state) is continuously monitored.
   1) If connecting state is bad, Time index of the received data until now is saved, and set Connecting Interruption flag is set, and the data receiving sensitivity (connecting state) is continuously monitored.
   2) If connecting state is good,
      a. If reconnection is necessary (connection is interrupted during measurement and reconnection is necessary), then reconnect with the measurement device 30 by use of the saved connecting information and transmit Time index at the interruption time to the measurement device 30, and measured data from the interrupted time is received again and saved in a buffer.
      b. If reconnection is not necessary, save the received data in a buffer and do measurement operation continuously.
4. If measurement is finished, measured data is saved as file and finish the measurement.

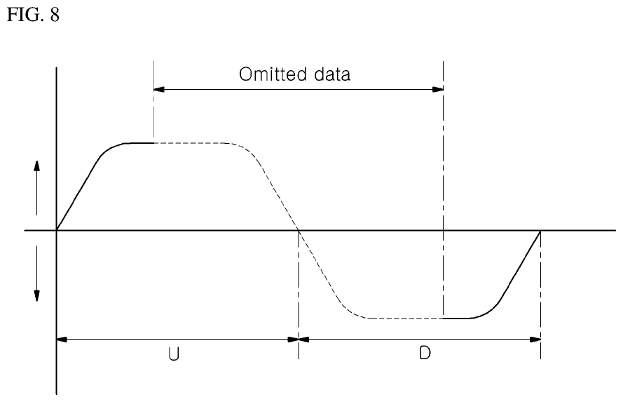

As describe above, even though communication disruption happens, the invention can retransmit the data saved in the memory when the communication is recovered, so the full process of measurement can be completely displayed on the display device 35, which will be explained in referring to FIG. 8.

As shown in FIG. 8, if an operator carries the display device 35 outside the building or on the ground floor and implement the measuring, the distance between the measuring device 30 and the display device 35 will be longer as the elevator runs upward. As the distance between the device is longer, sensitivity of the communication module such as Wi-Fi is deteriorated, accordingly disruption of data communication may happen.

FIG. 8 shows the running speed of the elevator 10 divided by ascending section U and descending section D. In ascending section U, the elevator is accelerated from the starting time to a predetermined time, then is kept constant speed, and is decelerated and is stopped finally. Similarly, in descending section D, the elevator is processed through acceleration, constant speed and deceleration.

Suppose that, during the ascending section U, the elevator 10 reaches 2 or 3 floors, and then communication with the display device 35 on the ground floor is disrupted, and, during the descending section D, the elevator 10 reaches 2 or 3 floor and communication is resumed. In conventional case, the data would not be displayed on the display device 35 during communication disruption. But, according to the present invention, as soon as the communication is resumed, the data saved in the memory 47 can be transmitted, so the omitted data expressed by dot line in FIG. 8 can be normally displayed to enhance the reliability of measurement.

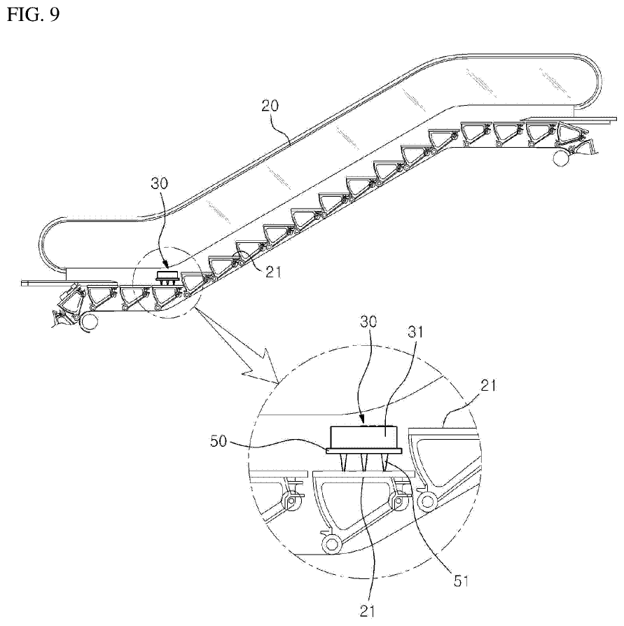

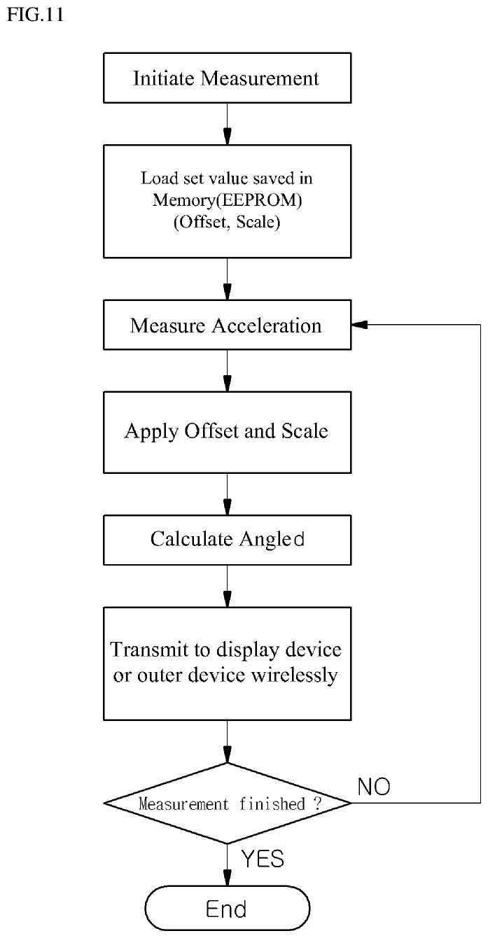

Meanwhile, the present invention can also used to measure the noise, vibration, running speed and inclination of the elevator 20, and example of measuring inclination will be explained in referring to FIG. 9 and FIG. 11.

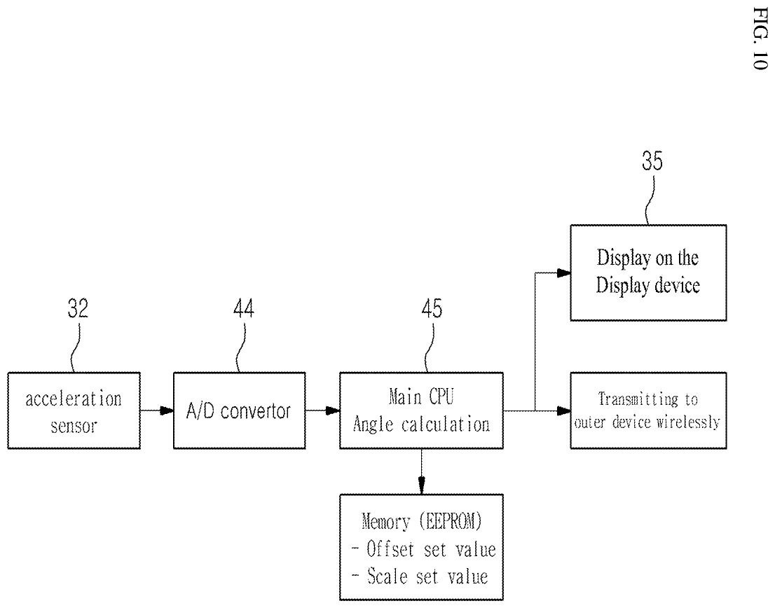

As shown in FIG. 9, the present invention can measure inclination of the escalator 20 as well as vibration, noise and running speed of the escalator 20. For this, the measurement device 39 is installed on the step tread 21 of the escalator 20 stably. Particularly, the measuring device 39 is installed on the first step tread 21 which starts to ascend in a state that the acceleration sensor 32 is placed horizontally. Then inclination transformation is implemented through the process in FIGS. 10 and 11.

As shown in FIGS. 10 and 11, an inclination measuring algorism according to the present invention calculates the vertical component and horizontal component of the data measured by the acceleration sensor 32 for the inclinedly moving escalator 20 and converse them into inclined moving amount and calculate speed, moving amount and inclination.
(1) Calibration Step
   place the acceleration sensor 32 on the step tread 21 of the escalator 20 horizontally and set the horizontal analog indication value output from the acceleration sensor 32 as reference value (OFFSET) and save it in memory (EEPROM).
   The acceleration sensor 20 is rotated to the angle of the designated measurement range (Range) by using escalator 20 and set the horizontal analog indication value output from the acceleration sensor 32 as maximum calibration value (CALMAX).
   calculate angle scale value (SC) according to the formula as below and save it in memory (EEPROM).

$$S C = \frac{measured analog vale}{measuring range} = \frac{( CALMAX - OFFSET )}{RANGE}$$

(2) Measuring Step
   Converse the horizontal analog indication value (ACC) output from the acceleration sensor 32 to angle value by use of the saved value in calibration step according to the formula as below.

Angle=ArcSine((ACC-OFFSET)*(SC/90.0)*180.0/3.141592654

Even though the present invention is described above in referred to the preferred embodiment, the invention should not be restricted by the above embodiment and the drawings, and various change and modification will be possible within the scope of the idea of the present invention.

1. A system for measuring noise, vibration and running speed of an elevator and escalator which comprises:
a measurement body 31 to be installed on the inner floor or a step tread 1 of an elevator 10 or an escalator 20;
an acceleration sensor 32 installed on the measurement body 31 to detect the acceleration of the running elevator 10 or escalator 20;
a noise sensor 33 connected to the measurement body 31 to detect noise inside the elevator 10 or noise on the predetermined position above the step tread 21 of the escalator 30;
a control unit 34 installed on the measurement body 31 to receive and process data from the acceleration sensor 32 and the noise sensor 33 and the control unit having a communication module 46 to communicate with outer device wirelessly and a memory 47 to save the data from the acceleration sensor 32 and the noise sensor 33; and
a display device 35 being separated from the measurement body 31, receiving data from the measurement body 31 and displaying the data including speed, vibration, decibel of noise and angle by numerical value or graph; wherein
the control unit 34 being capable of communicating with the display device 35 in real time, and if data omission happens due to communication disruption, a data saved in the memory 47 should be transmitted again to the display device 35 when communication is recovered so that they can be displayed through the display device 35.

2. A system for measuring noise, vibration and running speed of an elevator and escalator of claim 1, wherein the system further includes a supporting plate 50 having three legs 53 to be placed on the floor of elevator or the step tread 21 of the escalator 21, on which the measurement body 31 is installed.

3. A system for measuring noise, vibration and running speed of an elevator and escalator of claim 2, wherein the legs 51 are formed of tapered shape in which the cross section gradually reduces toward the floor of the elevator 10 or the step tread 21 of the escalator.
